(19) United States
(12) Patent Application Publication
(10) Pub. No.: US 2013/0191576 A1
(43) Pub. Date: Jul. 25, 2013

(54) COMPUTER SYSTEM AND METHOD FOR CONTROLLING ADDITIONAL CHASSIS ADDED TO COMPUTER SYSTEM

(71) Applicants: Chengtao Chiang, Odawara (JP); Yoshifumi Mimata, Odawara (JP); Takashi Itoyama, Odawara (JP)

(72) Inventors: Chengtao Chiang, Odawara (JP); Yoshifumi Mimata, Odawara (JP); Takashi Itoyama, Odawara (JP)

(73) Assignee: HITACHI LTD., Tokyo (JP)

(21) Appl. No.: 13/500,118

(22) PCT Filed: Jan. 24, 2012
(86) PCT No.: PCT/JP12/00437

§ 371 Date: Apr. 4, 2012

(51) Int. Cl. G06F 13/14

(52) U.S. Cl. 710/305

(57) ABSTRACT

Regarding an additional storage chassis used by being connected to a basic chassis equipped with a storage controller, provided is a computer system capable of changing or updating a firmware environment of the additional storage chassis so that normal operation of the additional storage chassis can be secured on the user side even if the operation different from the operation, which was guaranteed at the time of factory shipment, is executed on the user.

The present invention provides a computer system including a basic chassis equipped with a storage controller for controlling data I/O between a host computer and a storage system, and an additional chassis equipped with a plurality of storage drives to configure the storage system, wherein when a connection-target additional chassis is connected to a connection-source additional chassis connected to the basic chassis, the storage controller compares a data communication attribute of the connection-target additional chassis with a data communication attribute of the connection-source additional chassis and updates the data communication attribute of the connection-target additional chassis in accordance with a comparison result.

### TECHNICAL FIELD

The present invention relates to a computer system in which an additional chassis constituting a storage system is connected to a basic chassis having a controller for controlling data transfer between a host computer and the storage system. Particularly, the invention relations to a computer system designed to exhibit proper properties on a user side by updating firmware of an additional chassis which is newly connected when a plurality of additional chassis are connected to the basic chassis and the operation different from the operation relating to the properties guaranteed at the time of factory shipment of the additional chassis is executed on the user side.

### BACKGROUND ART

A system handling large-scale data such as a data center is realized by a computer system equipped with a host computer and a storage system which is configured separately from the host computer. The storage system is known to store data in a plurality of storage drives, which are arranged in arrays, and further include a controller for controlling data I/O between the host computer and the plurality of storage drives.

Regarding the configuration of chassis for the storage system, there are a basic chassis containing he controller and additional chassis that contains a plurality of storage drives and is connected to the basic chassis; and the storage capacity can be expanded sequentially by connecting the plurality of additional chassis to the basic chassis (for example, Japanese Patent Application Laid-Open (Kokai) Publication No. 2007-25933).

### CITATION LIST

### Patent Literature

[PTL 1] Japanese Patent Application Laid-Open (Kokai) Publication No. 2007-25933

### SUMMARY OF INVENTION

### Technical Problem

Recently, SAS (Serial Attached SCSI) has been often used for additional chassis as data transfer interfaces between a host controller and the additional chassis from the viewpoint of high performance and scalability of data transfer speeds. If an enterprise-scale storage system is a target, the plurality of additional chassis can be connected to the host controller via a SAS expander serving as a relay device by means of a daisy chain topology.

There are two types of SAS expanders: a SAS-1.0 type supporting a maximum data transfer speed of 3.0 Gbps; and a SAS-2.0 type supporting 6.0 Gbps. At the time of factory shipment of the additional chassis, an operation confirmation test at the maximum data communication speed of 3.0 Gbps is performed on the additional chassis having the SAS-1.0 type SAS expander and an operation confirmation test at the maximum data communication speed of 6.0 Gbps is performed on the additional chassis having the SAS-2.0 type SAS expander.

If the basic chassis is changed from an old type to a new type and the operation with an improved maximum data transfer speed is started on the user side, and then an additional chassis (in conformity with SAS-1.0) for the old-type basic chassis is diverted to and connected to the new-type basic chassis, the operation for which the maximum data transfer speed of an additional chassis (in conformity with SAS-2.0) for the new-type basic chassis is set to a low value for the old type is required.

From the above-described point of view, the additional chassis having the SAS-2.0 type SAS expander can be made to operate at the maximum data transfer speed of 3.0 Gbps by rewriting firmware of an enclosure controller.

However, since the operation confirmation of the additional chassis for the new-type basic chassis at the maximum data transfer speed of 6.0 Gbps is performed at the time of the factory shipment, this does not necessarily means that normal operation at the maximum data transfer speed of 3.0 Gbps is guaranteed.

On the other hand, it is not easy for the user side to check the operation of the additional chassis and rewrite the firmware of the enclosure controller. Therefore, the problem is that the user cannot actually use the additional chassis, which is intended for the use for the old-type basic chassis, for the new-type basic chassis.

So, regarding an additional storage chassis used by being connected to a basic chassis equipped with a storage controller, it is an object of the present invention to provide a computer system capable of changing or updating a firmware environment of the additional storage chassis so that normal operation of the additional storage chassis can be secured on the user side even if the operation different from the operation, which was guaranteed at the time of factory shipment, is executed on the user side.

### Solution to Problem

In order to achieve the above-described object, the present invention provides a computer system including a basic chassis equipped with a storage controller for controlling data I/O between a host computer and a storage system, and an additional chassis equipped with a plurality of storage drives to configure the storage system, wherein when a second additional chassis is connected to a first additional chassis connected to the basic chassis, the storage controller compares a data communication attribute of the second additional chassis with a data communication attribute of the first additional chassis and updates the data communication attribute of the second additional chassis in accordance with a comparison result.

According to the present invention, when the second additional chassis is connected to the first additional chassis connected to the basic chassis, the storage controller compares the data communication attribute of the second additional chassis with the data communication attribute of the first additional chassis and updates the data communication attribute of the second additional chassis in accordance with the comparison result. Therefore, normal operation of the second additional chassis can be realized on the user side.

### Advantageous Effects of Invention

Regarding an additional storage chassis used by being connected to a basic chassis equipped with a storage controller, it is possible to provide a computer system according to the present invention capable of changing or updating a firmware environment of the additional storage chassis so that normal operation of the additional storage chassis can be secured on the user side even if the operation different from the operation, which was guaranteed at the time of factory shipment, is executed on the user side.

### BRIEF DESCRIPTION OF DRAWINGS

FIG. 1 is a hardware block diagram of a computer system according to an embodiment of the present invention.

FIG. 2 is a block diagram showing a software configuration of a control memory (CS/DS) for the computer system.

FIG. 3 is a block diagram showing a storage configuration of a cache memory.

FIG. 4 is a block diagram showing an example of a connection configuration of a basic chassis and a plurality of additional chassis composed of first to fourth additional chassis.

FIG. 5 is a flowchart illustrating the operation of a controller for the basic chassis when connecting a new additional chassis to a new-type basic chassis whose data communication standard has been updated.

FIG. 6 is a flowchart showing the details of judgment processing on a firmware revision of an enclosure controller for a connection-target additional chassis (a step in part of FIG. 5).

FIG. 7 is a firmware revision management table for managing firmware revisions of enclosure controllers for the additional chassis.

FIG. 8 is a mapping table of firmware revisions of the enclosure controllers for the additional chassis.

FIG. 9 is an example of a management table for judging the necessity to update the firmware revisions of the enclosure controllers for the additional chassis.

FIG. 10 is an example of a management table for judging the necessity to diagnose the additional chassis.

FIG. 11 is a detailed flowchart of a diagnosis necessity judgment check.

FIG. 12 is a flowchart of diagnostic processing according to a diagnostic mode.

FIG. 13 is a flowchart of drive chassis expansion processing according to another embodiment.

### DESCRIPTION OF EMBODIMENTS

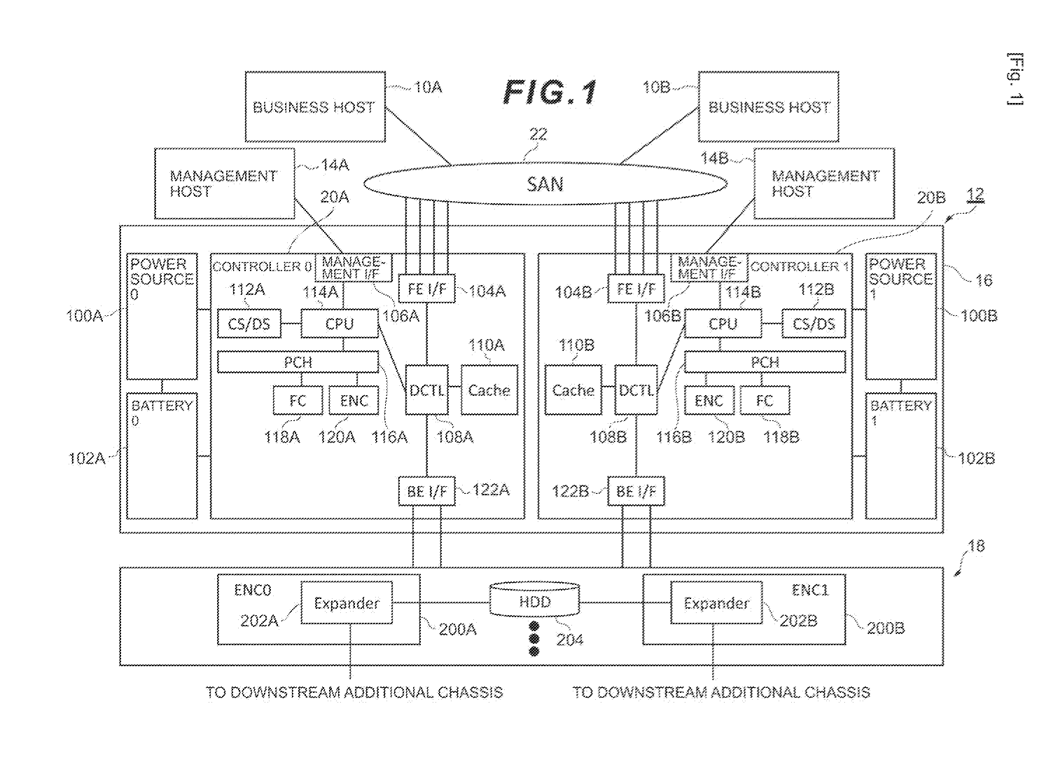

Next, an embodiment of the present invention will be explained. FIG. 1 is a hardware block diagram of a computer system according to an embodiment of the present invention. This computer system is configured so that it includes a plurality of business host computers 10 (10A, 10B), a storage system 12, and management host computers 14 (14A, 14B). The storage system 12 is constituted from a basic chassis 16 as a storage controller chassis and one or more additional storage chassis 18. The business host 10 has business applications.

An additional storage chassis 18 is configured so that a plurality of storage drives 204 are arranged in arrays; and the storage capacity can be expanded sequentially depending on a data amount by combining an additional chassis with another additional chassis relative to the host computer 10. On the other hand, the basic chassis 16 is equipped with storage controllers 20 (20A, 20B) for controlling data I/O between the host computer 10 and the additional chassis 18. As shown in FIG. 1, the basic chassis 16 has a multiple controller configuration (a 0-system controller 20A and a 1-system controller 20B) for the sake of redundancy of control resources. Both the controllers are connected to the plurality of business host computers 10 mentioned earlier via a network 22 such as a SAN.

Next, the configuration of the basic chassis 16 will be explained. Since the plurality of controllers have the same configuration, the configuration of the first controller 20A will be explained; and regarding the configuration of the second controller 20B, the same reference numeral used for the configuration of the first controller 20A (however, the reference numeral of the configuration of the first controller and the reference numeral of the configuration of the second controller will be distinguished by [A, B]) is assigned and its explanation has been omitted.

The reference numeral 100A represents a power source for the first controller 20A and the reference numeral 102A represents a battery as an emergency power source. The first controller 20A has a management interface 106A connected to the management host computer 14A and a front-end interface (FE I/F) 104A connected to the SAN. The management host computer 14A is connected to the management interface 106A of the first controller 20A and the management host computer 14B is connected to the management interface 106B of the second controller 20B. A management module of the storage controller is mounted in each management host computer 14A, 14B and controls and manages, for example, the settings and changes of configuration information of the basic chassis 16.

The front-end interface 104A is connected to a data controller (DCTL) 108A and a back-end interface 122A, a cache memory 110A, and a CPU 114A are connected to the data controller 108A. The CPU 114A is connected to the management interface 106A, A CS/DS 112A. is a control memory connected to the CPU 114A.

The CPU 114A is connected to a platform controller hub (PCH) 116A composed of a chip set. A flash controller (PC) 118A and an enclosure controller (ENC) 120A are connected to the PCH 116A.

The CPU 114A controls the data controller 108A which executes I/O processing (write access or read access) on the additional chassis 18 in response to an I/O request from the host computer 10A, 10B. The CS/DS 112A stores base firmware of the CPU 1145 as well as various control programs as described later and also functions as a work area for the CPU 114A.

The data controller 108A controls data transfer between the host computers 10A, 10B and the storage drives of the additional chassis 18 via the front-end interface 104A and the back-end interface 122A. More specifically, the data controller 108A writes write data to the cache memory 110A in response to write access from the host computer 10A, 10B. Subsequently, at a stage where the write data in the cache memory 110A has been accumulated to a certain degree, the data is staged to the storage drives of the additional chassis 18.

On the other hand, the data controller 108A writes read data, which has been read from the storage drives 204 of the additional chassis 18, to the cache memory 110A in response to read access from the host computer 10A, 10B and transfers the read data to the host computer 14A, 14B.

The data controller 108A provides logical volumes of a LAID group composed of a plurality of storage drives existing in one or more additional chassis 18 to the host computers 10A, 10B. The data controller 108A executes data I/O, which has been issued from the host computer 10A, 10B to a specified logical volume, on the storage drives constituting that logical volume.

The platform controller hub 116A connects the CPU 114A, the flash controller 118A, and the enclosure controller 120A mutually. The flash controller 118A controls booting of the basic chassis 16 and the additional chassis 18.

The enclosure controller 120A is a management controller module in the basic chassis 16 and monitors and controls the system environment such as the temperature, power, hardware configuration, and network configuration of the system. The reference numerals 200A, 200B represent enclosure controllers for the additional chassis. Attributes such as revisions of the firmware of the enclosure controller 120A have an effect on data processing properties such as a data communication speed. The same applies to the enclosure controllers 200A, 200B for the additional chassis.

The cache memory 110A is a buffer memory for temporarily storing data to be written to the additional chassis 18 or data which has been read from the additional chassis 18. The cache memory may be configured as a large-capacity memory composed of disk arrays.

Next, the additional chassis 18 connected to the basic chassis 16 will be explained. The additional chassis 18 includes double enclosure controllers (ENC) 200A (ENC0), 200B (ENC1) according to the multiple configuration of the controllers (20A, 20B) for the basic chassis 16. The first ENC 200A is connected to the first back-end interface (BE I/F) 122A and the second ENC 200B is connected to the second back-end interface (BE I/F) 122B.

Each ENC 200A, 200B of the additional chassis is equipped with an expander 202A, 202B. Each expander 202A, 202B is connected to a plurality of SAS-standard hard disk drives (SASHDD) 204 and executes data transfer between the basic chassis 16 and the HDD 204. Therefore, the HDD can be accessed from both the first ENC 200A and the second ENC 200B. The expander 202A, 202B is hardware to connect the additional chassis 18 to the basic chassis 16 and further connect the additional chassis to another additional chassis. As described earlier, the firmware of the ENC 200A, 200B for the additional chassis 18 has an effect on data transfer control of the expander 202A, 202B.

There are two types of the expanders 202A, 202B: a type according to the SAS-1.0 standard and a type according to the SAS-2.0 standard. The former type supports a maximum data transfer speed of 3.0 Gbps and the latter type supports maximum data transfer speeds of 6.0 Gbps and 3.0 bps.

Regarding the operation described later according to the present invention, there are examples of the additional chassis according to the SAS-1.0 standard and the additional chassis according to the SAS-2.0 standard; however, an SAS standard that supports a maximum data transfer speed of 12.0 Gbps is also advocated, so that the SAS standard to which the present invention should be applied is not limited and can be applied to various data communication properties.

The plurality of additional chassis are connected by their respective expanders by means of a daisy chain topology. The daisy chain means to string the plurality of additional chassis together in a beaded manner and connect them to the basic chassis.

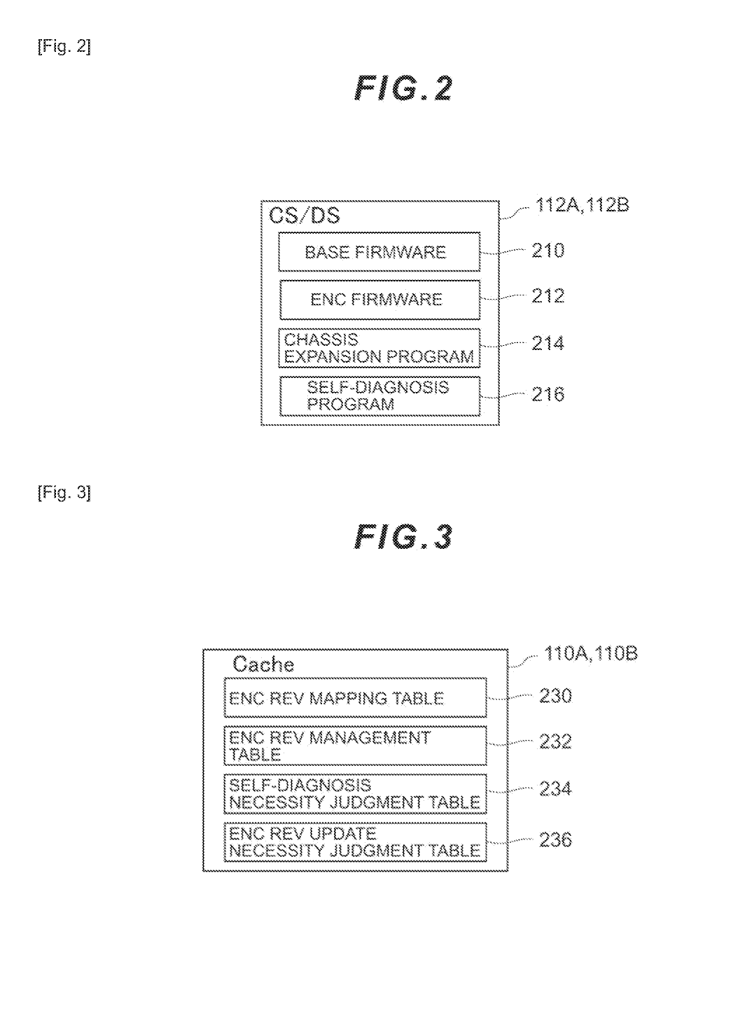

FIG. 2 is a block diagram showing a software configuration of the control memory (CS/DS) 112A, 112B. The CS/DS stores base firmware 210 responsible for basic operation such as data transfer control by, for example, the CPU 114A, 114B and the data controller 108A, 108B, firmware 212 of a plurality of revisions of the enclosure controllers (ENC), a chassis expansion program 214, and a self-diagnosis program 216.

The ENC firmware 212 of the enclosure controller (ENC) 120A, 120B for the basic chassis has an effect on the data transfer properties with respect to the additional chassis 18. Therefore, as the basic chassis is renewed, that is, as a revision of the ENC firmware in accordance with a change of the communication standard for the basic chassis is renewed, the data transfer properties, such as the maximum data transfer speed, which are desired for the new-type basic chassis cannot be achieved by the additional chassis unless the firmware of the ENC 200A, 200B for the additional chassis 180 is updated.

Then, since the plurality of additional chassis are stringed together in a beaded manner as described above, a new additional chassis, that is, a connection-target additional chassis, cannot achieve normal data transfer to/from a connection-source additional chassis unless the attribute of the ENC firmware of the connection-target additional chassis matches the attribute of the ENC firmware of the connection-source additional chassis, for example, unless the connection-target additional chassis can achieve the same maximum data transfer speed as that of the connection-source additional chassis.

Whether the ENC firmware of the new additional chassis is optimum or not differs depending on the type of the ENC firmware of the basic chassis, the type of the new additional chassis, and the type of the connection-source additional chassis as described above. The type of the additional chassis means, for example, the communication standard for the expander.

Therefore, since the attribute of the ENC firmware of the new additional chassis changes in the new additional chassis connection environment, a plurality of new and old revisions of the ENC firmware are stored in the control memory (CS/DS) 112A, 112B in order to prepare for the change.

Different combinations of the chassis that can guarantee data transfer at the maximum data transfer speed of 6 Gbps or 3 Gbps are required depending on differences of revisions of the ENC firmware of the additional chassis 18. In other words, the basic chassis may be of the old type or the new type, the chassis to be added may be for the new type or the old type, and the connection-source additional chassis for the chassis to be added may be for the new type or the old type.

Therefore, a data transfer speed which was not guaranteed at the time of factory shipment of the additional chassis can be made effective on the user side by downloading the ENC firmware of a different revision on the user side from, for example, the basic chassis 16. This will be explained later in detail.

The chassis expansion program 216 executes setting and control to connect a new additional chassis to the basic chassis or connection-source additional chassis and the self-diagnosis program 218 executes diagnosis of the new additional chassis.

FIG. 3 is a block diagram showing a storage configuration of the cache memory 110A, 110B. The cache memory stores a plurality of management tables necessary for the execution of the base firmware 210, the ENC firmware 212, the chassis expansion program 214, and the self-diagnosis program 216. These stored tables are: an ENC Rev mapping table 230 indicating the locations of revisions (ENC Rev) of the firmware of the enclosure controllers (ENC) of each chassis (the basic chassis and the additional chassis); an ENC Rev management table 232 for managing the ENC Rev; a self-diagnosis necessity judgment table 234 for judging the necessity of the self-diagnosis of a new additional chassis; and an ENC Rev update necessity judgment table 236 for judging the necessity of an update of the ENC Rev. The details of each of these tables will be explained later.

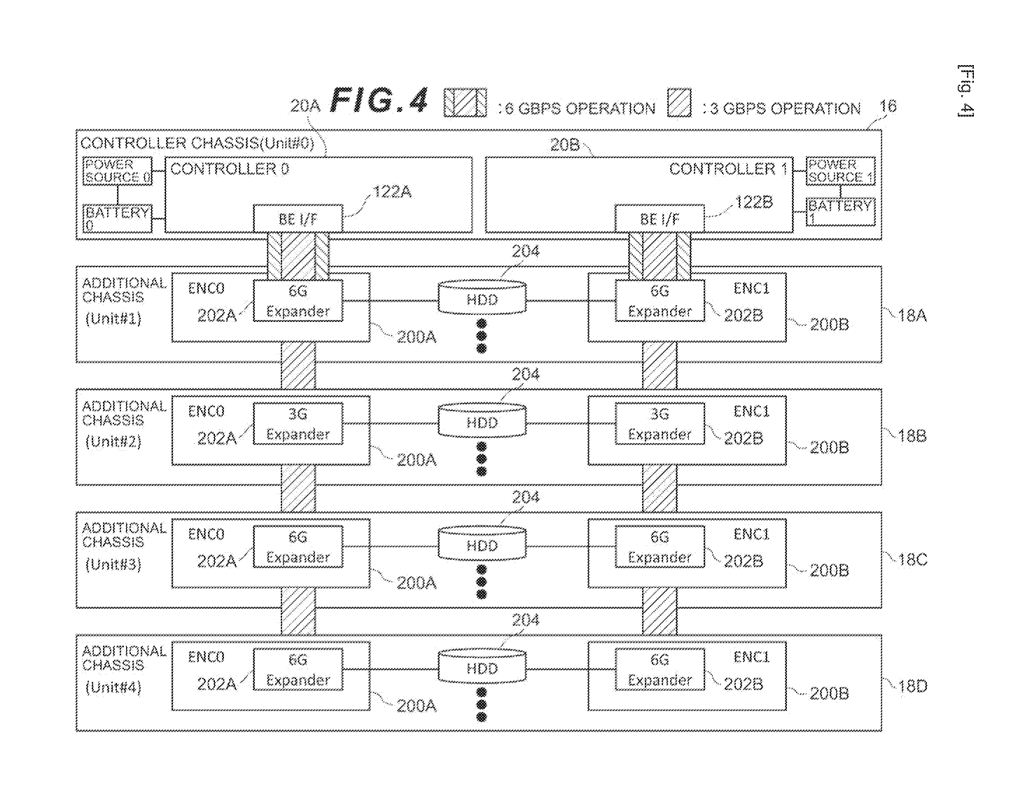

FIG. 4 is a block diagram showing an example of a connection configuration between the basic chassis 16 and a plurality of additional chassis 18, that is, first to fourth additional chassis (18A, 18B, 18C, 18D). The plurality of additional chassis 18 are connected to the basic chassis 16 by the daisy chain method. It is assumed that the basic chassis 16 is of a new type conforming to the SAS-2.0 and supporting data transfer at the maximum data transfer speed of 6.0 Gbps.

On the other hand, the old-type basic chassis is of a type conforming to the SAS-1.0 and supporting the maximum data transfer speed of 3.0 Gbps. The first, third, and fourth additional chassis 18A, 18C, 18D among the four additional chassis are equipped with the expanders 202A, 202B which conform to the SAS-2.0 in accordance with the specification of the new basic chassis. On the other hand, the expanders 202A, 202B of the remaining second additional chassis 18B conform to the SAS-1.0 standard in accordance with the specification of the old basic chassis and support data transfer at the maximum data transfer speed of 3.0 Gbps.

Although the third and fourth additional chassis conform to the SAS-2.0, they are located downstream from the second additional chassis, so that the maximum data transfer speed is limited to 3.0 Gbps. The operation of the third and fourth additional chassis at the maximum data transfer speed of 6.0 Gbps was confirmed at the time of the factory shipment, but the operation at the maximum data transfer speed of 3.0 Gbps was not confirmed. So, the third and fourth additional chassis cannot support the normal operation at the maximum data transfer speed of 3.0 Gbps for users. Therefore, conventionally, adaptation of the additional chassis for the old-type basic chassis, like the second additional chassis, to the new-type basic chassis has been avoided.

On the contrary, the computer system according to the present invention can provide the users with the normal operation of the additional chassis for the new-type basic chassis even when the additional chassis for the old-type basic chassis is connected to the new-type basic chassis. This will be explained below in detail.

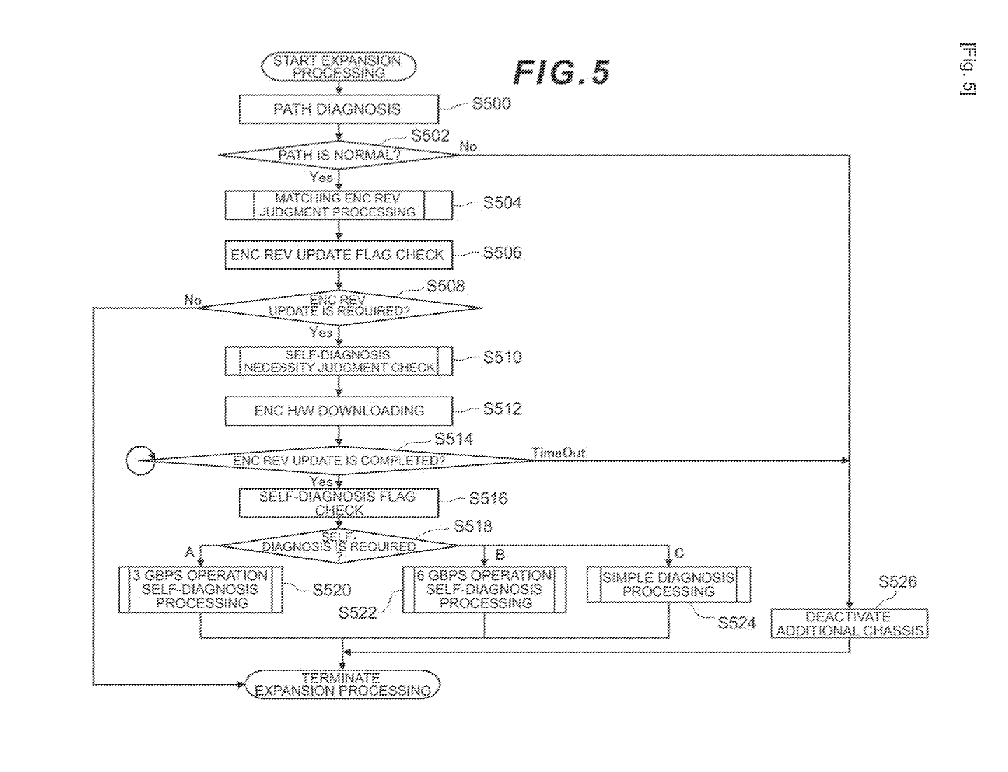

FIG. 5 is a flowchart illustrating the operation of the controller 20A (20B) for the basic chassis when connecting a new additional chassis to the new-type basic chassis whose data communication standard has been updated. The CPU 114A, 114B executes processing of this flowchart based on the chassis expansion program 216.

After the CPU 114A (114B) confirms that an additional chassis (connection-target additional chassis) is newly connected via the back-end interface 122A (122B) to an additional chassis (connection-source additional chassis) which is already connected to the basic chassis 16, the CPU 114A (114B) performs a path diagnosis between the expander for the connection-source additional chassis and the expander for the connection-target additional chassis in order to judge whether or not the connection-target additional chassis is normally connected to the connection-source additional chassis (S500). The path diagnosis herein used means a diagnosis to judge whether a physical connection between the two expanders is normal or not. If the CPU determines that the path is not normal (S502: No), the connection-target additional chassis is deactivated (S526) and the expansion processing is terminated. The CPU 114A (114B) has the management host or the business host display a connection failure message via the management I/F.

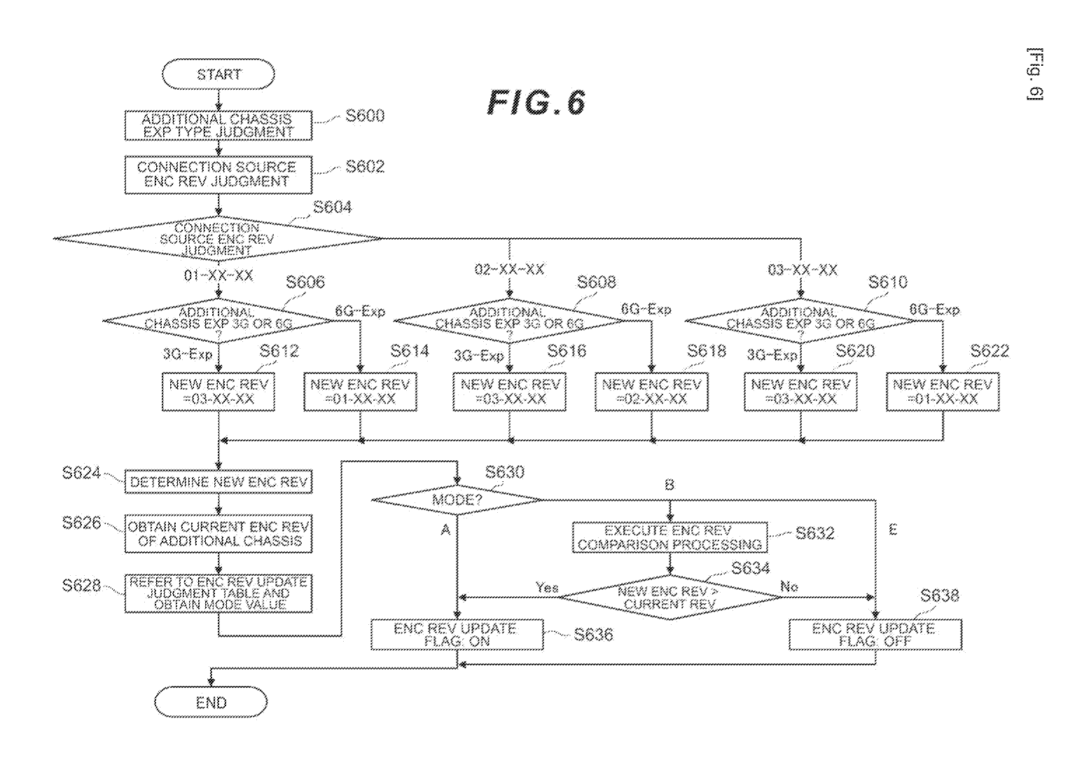

On the other hand, if it is determined that the path is normal (S502: Yes), the CPU executes processing for judging a revision of the firmware of the enclosure controller (ENC Rev) that matches the connection-target additional chassis (S504). FIG. 6 is a flowchart relating to this processing. Firstly, the CPU 114A (114B) for the basic chassis 16 executes discovery of the connection-target additional chassis and judges the type of the expander (Exp) 202A, 202B for the connection-target additional chassis 18 (S600). The Exp type indicates, for example, differentiation of the maximum data transfer speeds. For example, the Exp type distinguishes between the type corresponding to the maximum data transfer speed of 3.0 Gbps and the type corresponding to the maximum data transfer speed of 6.0 Gbps. In other words, the Exp type indicates the difference in the SAS standard specification.

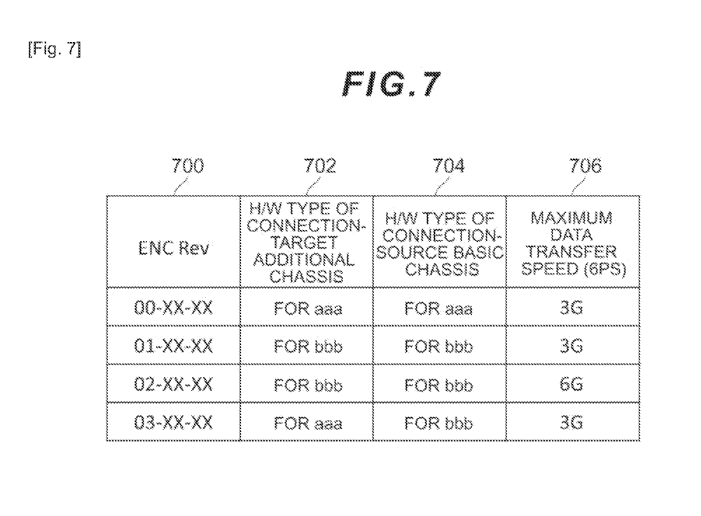

If the CPU 114A (114B) detects the connection-target additional chassis, it outputs an inquiry or discovery command via the data controller 108A (108B) to the connection-target additional chassis and obtains a revision (ENC Rev) of the firmware of the enclosure controller for the additional chassis 200A (200B). After the CPU obtains the ENC Rev, it refers to the ENC Rev management table 232 and identifies the Exp type. FIG. 7 is an example of this management table. This management table shows a correspondence relationship between the ENC Rev (700), the type of firmware (H/W) (702) of the enclosure controller (ENC) for the connection-target additional chassis, the H/W type (704) of the enclosure controller for the connection-source basic chassis, and the maximum data transfer speed (706) at which the connection-target additional chassis can operate. The Exp type is determined depending on the difference in the communication standard for the expander 202A (202B) of the ENC of the connection-target additional chassis.

The expression “for aaa” means that it is for the old-type basic chassis capable of supporting the maximum data transfer speed of 3.0 Gbps; and the expression “for bbb” means that it is for the new-type basic chassis capable of supporting the maximum data transfer speed of 6.0 Gbps or 3.0 Gbps. The ENC Rev (700) changes depending on how the H/W type (702) of the ENC of the connection-target additional chassis, the H/W type (704) of the ENC of the basic chassis, and the maximum data transfer speed (706) at which the operation of the connection-target additional chassis can be guaranteed are combined.

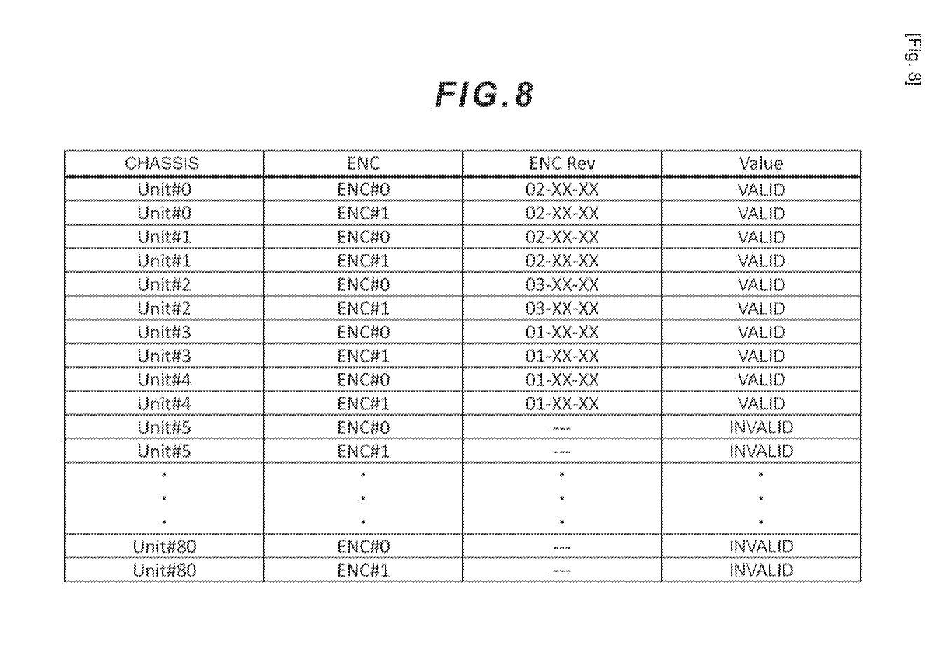

Next, the CPU 114A (114B) refers to the mapping table (FIG. 8) of revisions (ENC Rev) of the firmware of the enclosure controllers and identifies the ENC Rev of the connection-source chassis (S602). The table shown in FIG. 8 associates the ID of the enclosure controller (ENC) for each chassis including the basic chassis and the additional chassis with the ENC Rev and the validity (whether valid or invalid) of the ENC Rev. Unit #0 is the basic chassis 16. Units #1 to #80 represent the respective additional chassis.

The ENC Rev of each Unit #0 to #4 is valid. In other words, these additional chassis are connected to the basic chassis (see FIG. 4). No valid ENC Rev is registered in the ENC of each chassis with Unit #5 to #80. In other words, these additional chassis are not connected to the connection-source additional chassis. Therefore, the word “invalid” is registered in the validity field of the management table with respect to these chassis. FIG. 8 shows that a maximum of 80 pieces of additional chassis can be connected to one basic chassis by the daisy chain method.

If the connection-target additional chassis is connected to the connection-source additional chassis of the computer system and the controller 20A (20B) for the basic chassis executes the processing of the flowchart in FIG. 5 and finishes executing the processing in S520, S522, S524, that is, if the connection of the connection-target additional chassis is properly set, the related information is registered in the management table in FIG. 8 and “valid” is registered. The ENC Rev of the connection-target additional chassis regarding which “valid” is registered matches the connection-source chassis according to the flowchart in FIG. 5. If the ENC Rev already existing in the enclosure controller 200A (200B) for the connection-target additional chassis 18 matches the connection-source chassis, such already existing ENC Rev is the matching ENC Rev; and if there is no already existing ENC Rev that matches the connection-source chassis, the matching ENC Rev is downloaded from the basic chassis 16.

When the basic chassis 16 downloads the ENC firmware of a specified revision to a local memory for the ENC of the additional chassis 18, it registers information indicating that the revision of the ENC firmware is valid, in the management table shown in FIG. 8. The CPU 114A (114B) can find out the ENC Rev of the connection-source additional chassis by referring to this table (S602).

Next, the CPU identifies the ENC Rev of the connection-source additional chassis (S604) and identifies the expander type of the connection-target additional chassis (S600), thereby determining an optimum ENC Rev for the connection-target additional chassis. The optimum ENC Rev for the connection-target additional chassis means an ENC Rev capable of supporting data transfer at the maximum data transfer speed supported by the connection-source additional chassis. This will be explained in detail.

If the CPU 114A (114B) determines that the ENC Rev of the connection-source chassis is “01-XX-XX” and the type of the expander (Exp) for the connection-target additional chassis supports 3.00 (the maximum data transfer speed of 3.0 Gbps) (S606), the CPU 114A (114B) determines the optimum ENC Rev to be “03-XX-XX” (S612).

This is because of the following reason. The fact that the Exp type of the connection-target additional chassis is 3.0 Gbps means that the connection-target additional chassis is for the old-type basic chassis. Therefore, the connection-target additional chassis should be the additional chassis for the old-type basic chassis, be connected to the new-type basic chassis, and support the maximum data transfer speed of 3.0 Gbps. The optimum ENC Rev for such connection-target additional chassis is “03-XX-XX” according to the management table shown in FIG. 7.

On the other hand, if the expander type of the connection-target additional chassis is 6.00 (the maximum data transfer speed of 6.0 Gbps) (S606), the CPU determines that the optimum ENC Rev is “01-XX-XX” (S614). This is because of the following reason. The fact that the Exp type of the connection-target additional chassis is 6.00 means that the connection-target additional chassis should be for the new-type basic chassis and connected to the new-type basic chassis, but its maximum data transfer speed should be 3.0 Gbps. The optimum ENC Rev for such connection-target additional chassis is “01-XX-XX” according to the management table shown in FIG. 7.

If the ENC Rev of the connection-source chassis is “02-XX-XX” and the Exp type of the connection-target additional chassis is 3.00 (S608), the CPU determines the optimum ENC Rev to be “03-XX-XX” (S616).

This is because of the following reason. The fact that the Exp type of the connection-target additional chassis is 3.00 means that the connection-target additional chassis is for the old-type basic chassis. Therefore, the connection-target additional chassis should be the additional chassis for the old-type basic chassis and connected to the new-type basic chassis and the maximum data transfer speed should be 3.0 Gbps. The optimum ENC Rev for such connection-target additional chassis is “03-XX-XX” according to the management table shown in FIG. 7.

On the other hand, if the Exp type of the new additional chassis is 6.00 (S608), the CPU determines that the optimum ENC Rev is “02-XX-XX” (S618). This is because of the following reason. The fact that the Exp type of the connection-target additional chassis is 6.00 means that the connection-target additional chassis should be for the new-type basic chassis and connected to the new-type basic chassis and its maximum data transfer speed should be 6.0 Gbps. The ENC Rev that matches such connection-target additional chassis is “02-XX-XX” according to the management table shown in FIG. 7.

If the ENC Rev of the connection-source chassis is “03-XX-XX” and the Exp type of the connection-target additional chassis is 3.00 (S610), the CPU determines that the optimum ENC Rev is “03-XX-XX” (S620).

This is because of the following reason. The fact that the Exp type of the connection-target additional chassis is 3.00 means that the connection-target additional chassis is for the old-type basic chassis. Therefore, the connection-target additional chassis should he the additional chassis for the old-type basic chassis and connected to the new-type basic chassis and its maximum data transfer speed should be 3.0 Gbps. The ENC Rev that matches such connection-target additional chassis is “03-XX-XX” according to the management table shown in FIG. 7.

On the other hand, if the Exp type of the connection-target additional chassis is 6.00 (S610), the CPU determines that the optimum ENC Rev is “01-XX-XX” (S622). This is because of the following reason. The fact that the expander type of the connection-target additional chassis is 6.0G means that the connection-target additional chassis should he for the new-type basic chassis and connected to the new-type basic chassis and its maximum data transfer speed should be 3.0 Gbps. The ENC Rev that matches such connection-target additional chassis is “01-XX-XX” according to the management table shown in FIG. 7.

As a result of the above-described processing, the CPU 114A (114B) determines the optimum new ENC Rev for the connection-target additional chassis according to the environment where the connection-target additional chassis is placed (S624).

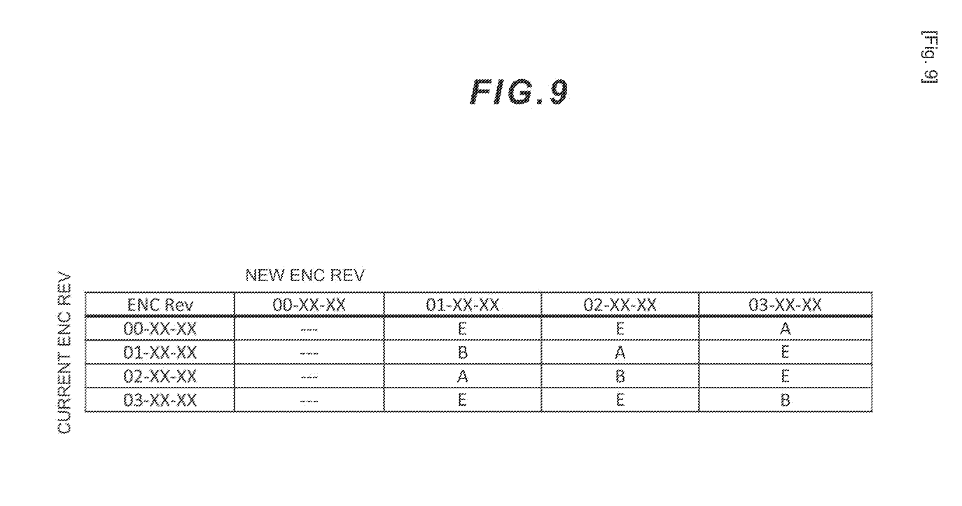

Next, the CPU obtains a current ENC Rev of the connection-target additional chassis from the management table (FIG. 8) (S626), compares the current ENC Rev with the optimum ENC Rev found in S612 through S622, and judges whether or not it is necessary to update the ENC firmware from the current revision to the optimum revision (S628). When making this judgment, the ENC Rev update necessity judgment table 236 is used. FIG. 9 is an example of this judgment table.

The table shown in FIG. 9 indicates a correspondence relationship between the current ENC Rev of the connection-target additional chassis and the new ENC Rev selected to be an optimum ENC Rev. “Mode A” indicates that the maximum data transfer speed supported by the connection-target additional chassis is not identical to the maximum data transfer speed supported by the connection-source chassis; and if the connection-target additional chassis is used by keeping the current. ENC Rev, there is a possibility that normal data transfer might not be executed; and it is necessary to update the current ENC Rev of the connection-target additional chassis by downloading the above-mentioned new ENC Rev, which supports the same maximum data transfer speed as that of the connection-source additional chassis, to the connection-target additional chassis.

“Mode B” indicates that it is not indispensable to update the ENC Rev of the connection-target additional chassis in order to support the same maximum data transfer speed as that of the connection-source additional chassis; however, if there is the same revision which is the latest version, that is, if the value “XX-XX” of the new ENC Rev is larger than the value “XX-XX” of the current ENC Rev, the current ENC Rev may be updated to the new ENC Rev.

In “Mode E,” the data communication standard supported by the connection-target additional chassis (communication standard supported by the expander) is of a different type from that of the data communication standard supported by the new ENC Rev, For example, assuming that the current ENC Rev is “03-XX-XX” and the new ENC Rev is “02-XX-XX,” the former is supported by the SAS-1.0 and the latter is supported by the SAS-2.0 according to the management table shown in FIG. 7. So, if the current ENC Rev of the connection-target additional chassis is updated to the new ENC Rev, there is a possibility that normal data transfer might not be performed at the connection-target additional chassis.

In the above-described case, “Mode E” indicates that since the new ENC Rev does not match the connection-target additional chassis, the ENC Rev should not be updated. The CPU 114A (114B) determines the mode based on the current ENC Rev of the new additional chassis and the new ENC Rev by using the judgment table shown in FIG. 9 (S628).

Incidentally, “-” in the judgment table shown in FIG. 9 (when the new ENC Rev is “00-XX-XX”) indicates that mode determination processing is not necessary. This is because the computer system according to this embodiment is designed on the premise that the basic chassis is of the new type, so that the ENC Rev which requires the basic chassis to be of the old type will not be selected.

The CPU 114A (114B) determines the mode (S630); and if the CPU 114A (114B) determines that the mode is [A], it sets an ENC Rev update flag to on (S636). This flag is set to a specified area in the cache memory 110A (110B) for the basic chassis 16. If the CPU 114A (114B) determines that the mode is [E], it sets the ENC Rev update flag to off (S638).

If the CPU 114A (114B) determines that the mode is [B] and a version of the new ENC Rev is newer than that of the current ENC Rev, it sets the update flag to on (S634: Yes). Otherwise, the CPU 114A (114B) sets the update flag to off (S634: No).

Next, the CPU 114A (I14B) returns to a main routine of FIG. 5 and checks the update flag (S506). If the CPU 114A (114B) determines that the update flag is off (S514: No), it terminates the expansion processing. If the CPU 114A (114B) determines that the update flag is on (S508: Yes), it performs a self-diagnosis necessity judgment (S510). The self-diagnosis necessity judgment means a judgment to determine the necessity of diagnosis to find out whether the new additional chassis operates normally or not when the ENC firmware of the connection-target additional chassis is updated to the new ENC Rev.

When an additional chassis is shipped, an operation test is performed in a factory at the maximum data transfer speed of 3 Gbps in a case of the additional chassis for the old-type basic chassis or at the maximum data transfer speed of 6 Gbps in a case of the additional chassis for the new-type basic chassis is performed in order to guarantee the operation; and then the tested additional chassis is shipped.

However, if an attempt is made to make the additional chassis for the new-type basic chassis operate at the maximum data transfer speed of 6 Gbps and then at the maximum data transfer speed of 3 Gbps and to make the additional chassis for the new-type basic chassis operate at the maximum data transfer speed of 3 Gbps and then change it to the operation at the maximum data transfer speed of 6 Gbps, the operation will not be guaranteed.

So, it is necessary to diagnose whether or not the connection-target additional chassis of the new ENC Rev can perform the normal operation at the maximum data transfer speed required by the new ENC Rev on the user side. Therefore, the logic of the self-diagnosis necessity judgment is added when adding the connection-target additional chassis on the user side.

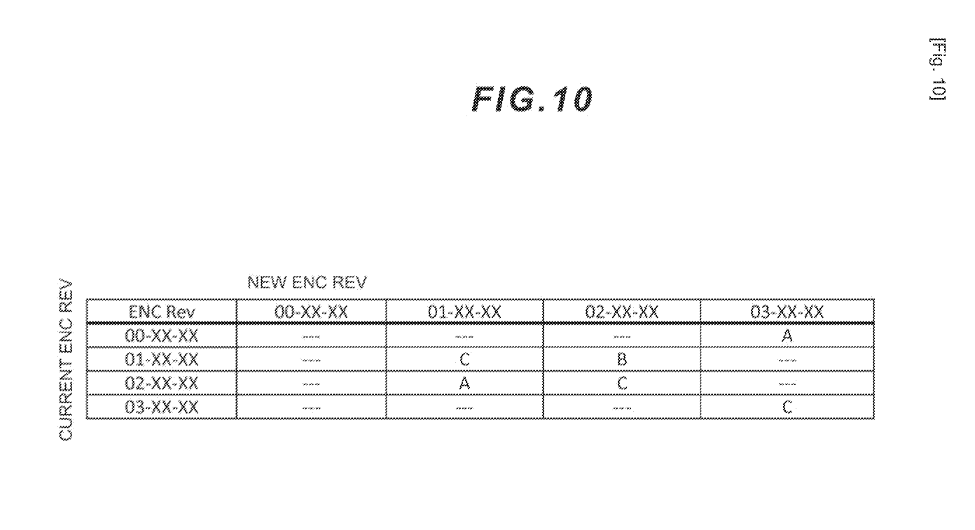

FIG. 10 is an example of the self-diagnosis necessity judgment table 234. In this table, “A” means that when the ENC Rev is updated so that the connection-target additional chassis for the old -type basic chassis can be applied from the old-type basic chassis to the new-type basic chassis, or when the ENC Rev is updated so that the additional chassis for the new-type basic chassis can be applied to the new-type basic chassis and be subject to an operation change to reduce the maximum data transfer speed from 6 Gbps to 3 Gbps, the self-diagnosis to confirm the normal implementation of data transfer at the maximum data transfer speed of 3 Gbps should be performed on the connection-target additional chassis.

On the other hand, “B” means that if the operation of the additional chassis for the new-type basic chassis is to be changed from the maximum data transfer speed of 3 Gbps to 6 Gbps as a result of the update of the ENC Rev, the self-diagnosis to confirm the normal implementation of data transfer at the maximum data transfer speed of 6 Gbps should be performed on the connection-target additional chassis. In this way, if the ENC firmware of the connection-target additional chassis is updated and the data transfer properties are to be changed, the self-diagnosis of the connection-target additional chassis is performed.

On the other hand, “C” means that the update of the ENC firmware is only an update of the same revision from an old version to a new version and the self-diagnosis after the update of the ENC firmware may be of a simple type.

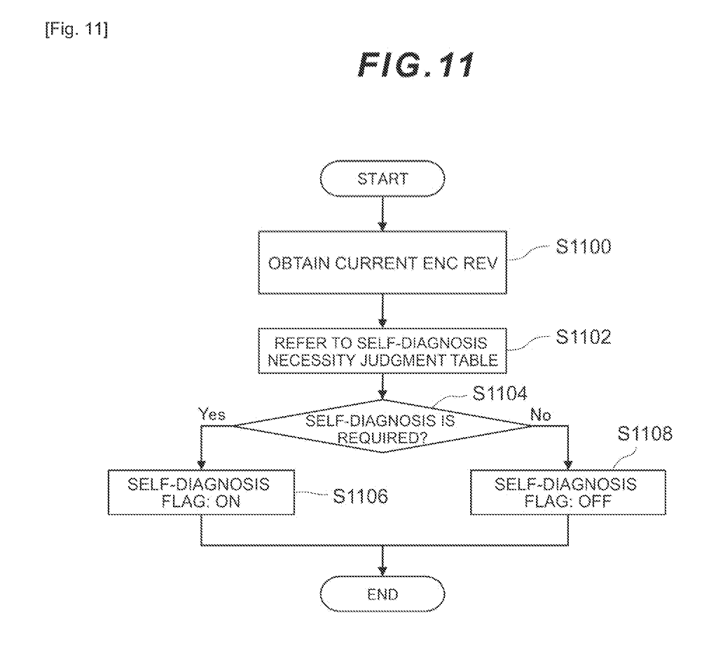

FIG. 11 is a flowchart illustrating the details of the self-diagnosis necessity judgment check. The CPU 114A (114B) executes the self-diagnosis program 216 and executes processing of the flowchart. Firstly, the CPU refers to the ENC Rev management table (FIG. 8) and obtains the current revision of the ENC firmware of the connection-target additional chassis (S1100).

Next, the CPU refers to the self-diagnosis necessity judgment table 234 (FIG. 10) (S1102) and judges whether the self-diagnosis after the update of the ENC firmware to the optimum revision is necessary or not (S1140). If a combination of the current revision and the optimum revision is any one of “A,” “B,” and “C,” the CPU determines that the self-diagnosis is necessary; and then the CPU sets the self-diagnosis flag to on (S1106), On the other hand, if a combination of the current revision and the optimum revision is not any of “A,” “B,” or “C,” the CPU determines that the self-diagnosis is unnecessary; and then the CPU sets the self-diagnosis flag to off (S1108).

Subsequently, the CPU 114A (114B) returns to the flowchart (FIG. 5) of the expansion processing and starts downloading the optimum revision firmware (H/W) to the ENC for the connection-target additional chassis, thereby updating the ENC Rev (S512). This download is executed by the CPU downloading the ENC Rev of the optimum revision from the control memory (CS/D) 112A, 112B to the local memory connected to the ENC for the connection-target additional chassis.

In step 514, whether the download (update) of the ENC Rev is completed or not is checked (S514). If a time-out-related failure occurs in the process of downloading, the additional chassis is deactivated (S526).

When the download is completed, the CPU checks the self-diagnosis flag (S516); and if the self-diagnosis flag is set to on, the CPU orders the connection-target additional chassis to execute the self-diagnosis for each self-diagnostic mode (S520, S522, S524). When this diagnostic processing terminates, the CPU terminates the chassis expansion processing.

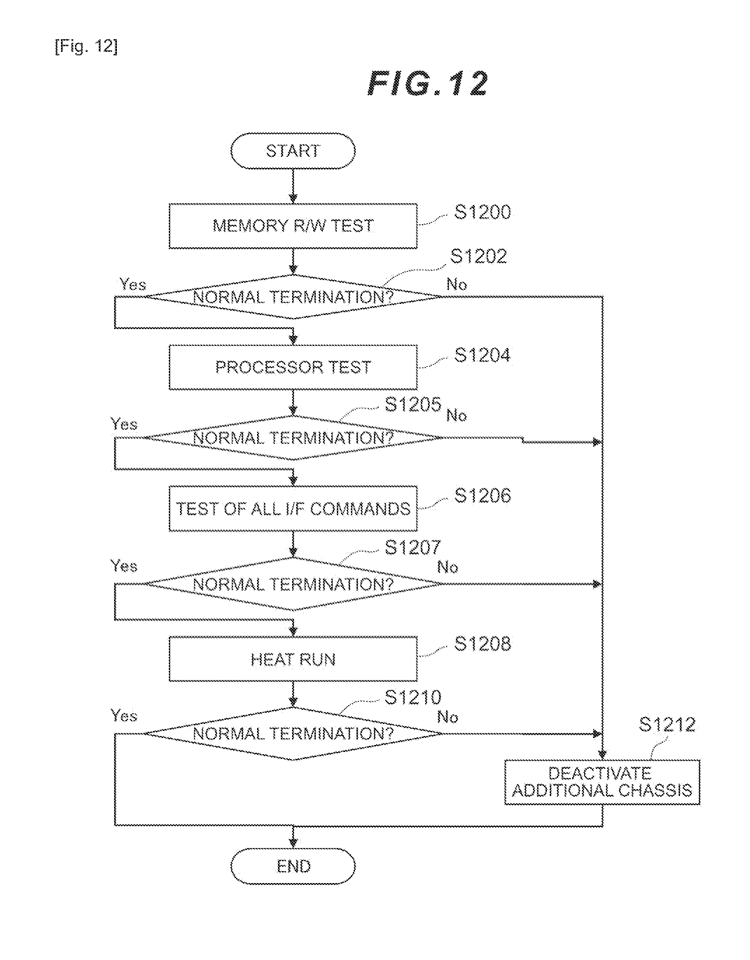

FIG. 12 is a flowchart of the self-diagnostic processing for the operation at the maximum data transfer speed of 3 Gbps when the self-diagnostic mode is “A.” This flowchart is achieved by the execution of the self-diagnosis program 216 by the CPU 114A (114B). The CPU 114A (114B) for the basic chassis 16 executes the self-diagnostic processing for the operation at the maximum data transfer speed of 3 Gbps on the enclosure controller 202A (202B) for the connection-target additional chassis.

The CPU sends an inquiry command to the connection-target additional chassis 18 and recognizes the connection-target additional chassis, and then performs an R/W test of the memory (S1200). This test is, for example, to test whether or not the same value as a value written to the memory (the control memory and the storage drives) can be read from the memory, to test whether or not there is any bit that remains to be 1 even if 0 is written to the memory, to test whether or not refresh to retain data storage of DRAM functions normally, and to test whether blocks of areas in the memory can he properly copied to another area.

When the CPU normally terminates this test (S1202), it executes a processor test of the connection-target additional chassis (S1204). This test is, for example, to test an amount of time it takes to terminates specified processing, to check stability of the operation of the additional chassis when imposing a high load on the processor, and to check a cache capacity and a speed.

Then, when the CPU normally terminates the processor test (S1205), it executes a test of all I/F commands (S1206). This test is to test whether the enclosure controller can operate normally when issuing an instruction from the basic chassis to the enclosure controller 202A (202B) for the connection-target additional chassis, to test an input/output speed, and to test data R/W confirmation. Subsequently, the CPU checks whether all the I/F commands terminate normally or not (S1207))

If the CPU executes the above-described tests and returns a negative judgment on at least one of the tests, it deactivates the connection-target additional chassis (S1212). If the CPU returns an affirmative judgment on all the above-mentioned tests, it executes heat run (S1208).

The heat run is a test to check, for example, whether or not data can be properly written to the drives at 3 Gbps/6 Gbps (the maximum data transfer speed) and check whether or not the maximum data transfer speed at the time of output satisfies 3 Gbps.

If the CPU determines that any of the above-described tests is normal, it means that even if the ENC firmware of the current revision of the connection-target additional chassis (the maximum data transfer speed: 6 Gbps) is updated to the ENC firmware of the optimum revision (the maximum data transfer speed: 3 Gbps) based on the data transfer properties of the connection-source additional chassis, such update is diagnosed as not causing a failure to the data transfer performance of the connection-target additional chassis.

Alternatively, it means that even if the ENC firmware of the current revision of the connection-target additional chassis (the maximum data transfer speed: 3 Gbps) is updated to the ENC firmware of the optimum revision (the maximum data transfer speed: 6 Gbps) based on the data transfer properties of the connection-source additional chassis, such update is diagnosed as not causing a failure to the data transfer performance of the connection-target additional chassis. This self-diagnostic processing corresponds to the self-diagnostic processing for the 6-Gbps operation in S522.

If the CPU does not determine that the heat run is normal (S1210: No), it deactivates the connection-target additional chassis (S1212). Incidentally, the simple diagnosis (S524) means a diagnosis from which the test of all I/F commands and the heat run are omitted (S1206 to S1210).

Next, another form of the drive chassis expansion processing will be explained. In the aforementioned embodiment, the processing for updating to the optimum ENC Rev is executed when connecting the additional chassis and the basic chassis executes the drive chassis connection processing (FIG. 5). On the other hand, the expansion processing shown in FIG. 5 may be executed by the basic chassis when booting the computer system composed of the basic chassis 16 and the additional chassis 18.

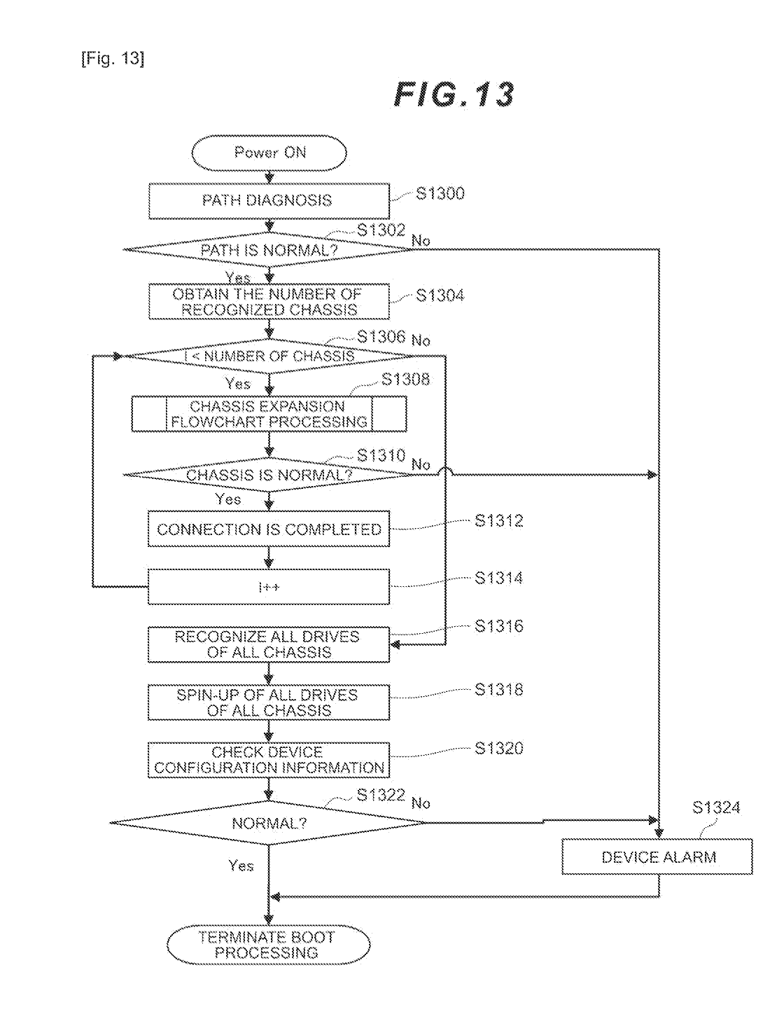

FIG. 13 is a flowchart of the processing described above. The processing is executed by the basic chassis 16. When booting the computer system, the CPU 114A (114B) diagnoses whether a physical connection to the enclosure controller 202A (202B) for the additional chassis 18 and a physical connection between the enclosure controllers for the additional chassis are appropriate or not (S1300).

If the path is normal (S1302: Yes), the back-end interface executes discovery of the additional chassis and recognizes the number of additional chassis existing in the system (S1304).

Next, the CPU 114A (114B) executes a normality diagnosis of all the additional chassis after each additional chassis is booted (S1310); and if an affirmative result is obtained for the normality diagnosis, the CPU 114A (114B) determines that the connection of each additional chassis is completed (S1312). When performing a specified check of each additional chassis, the basic chassis 116 executes the chassis expansion processing described earlier if there is any newly connected additional chassis (S1308).

When the basic chassis 16 executes S1314 to S1306 and finishes checking all the additional chassis including the new additional chassis (S1306: No), the basic chassis 16 executes discovery of all the storage drives of all the additional chassis and recognizes them (S1316), and then spins up all the storage drives of all the additional chassis.

Subsequently, the basic chassis 16 checks device information such as RAID configuration about all the chassis (S1320); and if the device configuration information is normal, for example, if the device configuration information matches the already set information (S1322: Yes), the system booting processing is recognized to have normally terminated. If there is any abnormality in the system booting processing (S1310: No; S1322: No), a device alarm is reported.

The aforementioned embodiment has described that the data transfer method used between the basic chassis and the additional chassis and between the additional chassis and the additional chassis is based on the SAS; however, a data transfer method based on the Fibre Channel may be used.

### REFERENCE SIGNS LIST

12 Computer system
16 Basic chassis
18 Additional chassis
120A, 120B, 200A, 200B Enclosure controllers
202A, 202B Expanders

1. A computer system comprising:
a basic chassis equipped with a storage controller for controlling data I/O between a host computer and a storage system; and
an additional chassis equipped with a plurality of storage drives to configure the storage system;
wherein when a second additional chassis is connected to a first additional chassis connected to the basic chassis, the storage controller compares a data communication attribute of the second additional chassis with a data communication attribute of the first additional chassis and updates the data communication attribute of the second additional chassis in accordance with a comparison result.

2. The computer system according to claim 1, wherein the storage controller updates firmware of an enclosure controller for the second additional chassis based on:
an attribute of the firmware of the enclosure controller as the data communication attribute of the first additional chassis; and
an attribute of an expander as the data communication attribute of the second additional chassis.

3. The computer system according to claim 2, wherein the storage controller determines an optimum revision of the firmware of the enclosure controller belonging to the second additional chassis.

4. The computer system according to claim 3, wherein the basic chassis includes a memory for storing a plurality of revisions of the firmware of the second additional chassis; and
wherein the storage controller identifies firmware of an optimum revision of the second additional chassis among the firmware of a plurality of revisions in the memory and downloads the firmware of the optimum revision to the enclosure controller belonging to the second additional chassis.

5. The computer system according to claim 2, wherein the storage controller determines the optimum revision for the second additional chassis according to a data communication standard type of the basic chassis.

6. The computer system according to claim 3, wherein the storage controller determines the optimum revision of the firmware of the enclosure controller belonging to the second additional chassis as one having an attribute capable of supporting a maximum data communication speed supported by the first additional chassis.

7. The computer system according to claim 4, wherein the storage controller compares a current revision of the firmware stored in the enclosure controller belonging to the second additional chassis with the determined optimum revision and determines whether or not to update the firmware of the enclosure controller belonging to the second additional chassis to the firmware of the optimum revision.

8. The computer system according to claim 7, wherein if the storage controller compares the current revision of the firmware stored in the enclosure controller belonging to the second additional chassis with the determined optimum revision and these revisions are different from each other, the storage controller updates the firmware of the enclosure controller belonging to the second additional chassis to the firmware of the optimum revision.

9. The computer system according to claim 7, wherein if the storage controller compares the current revision of the firmware stored in the enclosure controller belonging to the second additional chassis with the determined optimum revision and these revisions are the same and a version of the firmware of the optimum revision is newer than a version of the firmware of the current revision, the storage controller updates the firmware of the enclosure controller belonging to the second additional chassis to the firmware of the optimum revision.

10. The computer system according to claim 7, wherein if the storage controller compares a data communication standard supported by the second additional chassis with a data communication standard supported by the determined optimum revision and these data communication standards are not identical to each other, the storage controller does not update the firmware of the current revision to the firmware of the optimum revision.

11. The computer system according to claim 7, wherein if the storage controller determines to update the firmware of the enclosure controller belonging to the second additional chassis to the firmware of the optimum revision, it executes diagnostic processing on the second additional chassis based on the comparison result to judge whether the second additional chassis can achieve data transfer properties required by the firmware of the optimum revision.

12. The computer system according to claim 11, wherein if the storage controller determines that a result of the diagnostic processing on the second additional chassis is normal, it downloads the firmware of the optimum revision from the memory to the second additional chassis.

13. The computer system according to claim 11, wherein if the storage controller compares the current revision of the firmware stored in the enclosure controller belonging to the second additional chassis with the determined optimum revision and these revisions are the same, it executes the diagnostic processing in a simple manner.

14. An additional chassis control method for a computer system including:
a basic chassis equipped with a storage controller for controlling data I/O between a host computer and a storage system; and
an additional chassis equipped with a plurality of storage drives to configure the storage system;
wherein when a second additional chassis is connected to a first additional chassis connected to the basic chassis, the storage controller compares a data communication attribute of the second additional chassis with a data communication attribute of the first additional chassis and updates the data communication attribute of the second additional chassis in accordance with a comparison result.
